(19) United States
(12) Patent Application Publication
(10) Pub. No.: US 2016/0212100 A1
(43) Pub. Date: Jul. 21, 2016

(54) TRANSPARENT PROXY SYSTEM WITH AUTOMATED SUPPLEMENTAL AUTHENTICATION FOR PROTECTED ACCESS RESOURCES

(71) Applicant: Onion ID, Inc., Hayward, CA (US)

(72) Inventor: Anirban Banerjee, San Bruno, CA (US)

(21) Appl. No.: 15/002,632

(22) Filed: Jan. 21, 2016

Related U.S. Application Data
(60) Provisional application No. 62/125,402, filed on Jan. 21, 2015.

(51) Int. Cl. H04L 29/06

(52) U.S. Cl. CPC H04L 63/0281; H04L 63/08

(57) ABSTRACT

Techniques are disclosed herein for facilitating dynamic risk assessment and automated triggering of supplemental authentication for protected access resources. More specifically, the techniques described herein provide security mechanisms that can be triggered in response to a risk assessment determined in response to request to establish a connection between an access system and a protected resource. Alternatively or additionally, the security mechanisms can transparently monitor an authenticated connection between an access system and a resource and automatically trigger supplemental authentication based on a dynamic risk assessment. In some embodiments, a feature set of the authenticated connection and commands initiated over the authenticated connection are monitored and underlying information captured to dynamically generate the risk assessment or score. The supplemental authentication can be triggered when the risk score exceeds a risk threshold.

### RELATED APPLICATIONS

This application claims the benefit of and priority to U.S. Patent Application No. 62/125,402, filed on Jan. 21, 2015, and entitled “MFA for servers using transparent proxies,” and which is hereby incorporated by reference in its entirety.

### TECHNICAL BACKGROUND

Aspects of the disclosure are related to computing hardware and software technology, and more particularly, to an automated self-learning transparent proxy system for facilitating dynamic risk assessment and automated triggering of supplemental authentication for protected access resources.

### TECHNICAL BACKGROUND

Anyone with a suitable Internet appliance, such as a personal computer with a standard Internet connection, may access (or go on-line) and navigate web pages stored on Internet-connected servers for the purpose of obtaining information and initiating transactions with hosts of such servers and pages. For example, an employee of an enterprise can gain authorized access to secure servers such as, for example, production and/or website servers, from almost anywhere for the purposes of performing a variety of tasks.

Unfortunately, authorized access can give rise to exploitation of the secure servers for malicious purposes through access via compromised credentials, e.g., credentials that are stolen from individuals, organizations or applications. Furthermore, even when credential are not comprised, a rogue or disgruntled employee can wreak havoc on the secure servers. Today, there is no way to seamlessly monitor and securely control this access.

Overall, the examples herein of some prior or related systems and their associated limitations are intended to be illustrative and not exclusive. Upon reading the following, other limitations of existing or prior systems will become apparent to those of skill in the art.

### OVERVIEW

Provided herein are systems, methods, techniques, apparatuses and software that facilitate automated triggering of supplemental authentication for protected access resources. In some embodiments, a transparent proxy system is disclosed having one or more processors and one or more computer readable storage media with program instructions stored thereon, which when executed by the one or more processors, direct the one or more processors to perform various functions. In some embodiments, the functions include intercepting a command initiated by a resource access system over an authenticated connection, wherein the command is initiated for delivery to and execution by a protected resource. The functions further include generating a risk score based on a type of the command and a feature set corresponding to the authenticated connection, and triggering supplemental authentication if the risk score exceeds a risk threshold.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 depicts a block diagram illustrating an example environment including a transparent proxy system which is configured to observe and cluster resource(s) associated with an enterprise and to transparently provide varying levels of dynamic protected access to the resource(s), according to some embodiments.

FIGS. 2A-2C depict example components of a transparent proxy system, according to some embodiments.

FIG. 3 depicts an example timeline illustrating a learning period and security period of a transparent proxy system when serving resources associated with a particular enterprise, according to some embodiments.

FIG. 4 depicts a flow diagram illustrating example operation for facilitating dynamic risk assessment and automated triggering of supplemental authentication for a protected access resource, according to some embodiments.

FIG. 5 depicts another flow diagram illustrating example operation for facilitating dynamic risk assessment and automated triggering of supplemental authentication for a protected access resource, according to some embodiments.

FIG. 6 depicts a sequence diagram illustrating example operation of various devices, systems, and an end users for establishing an authenticated connection and subsequently triggering a supplemental authentication based on an intercepted command, according to some embodiments

FIG. 7 illustrates a computing system suitable for implementing any of the architectures, components, applications, services, processes, and operational scenarios disclosed herein with respect to FIGS. 1-6 and discussed below in the Technical Disclosure.

### TECHNICAL DISCLOSURE

Techniques are disclosed herein for facilitating dynamic risk assessment and automated triggering of supplemental authentication for protected access resources. More specifically, the techniques described herein provide security mechanisms that can be triggered in response to a risk assessment determined in response to request to establish a connection between an access system and a protected resource. Alternatively or additionally, the security mechanisms can transparently monitor an authenticated connection between an access system and a resource and automatically trigger supplemental authentication based on a dynamic risk assessment. In some embodiments, a feature set of the authenticated connection and commands initiated over the authenticated connection are monitored and underlying information captured to dynamically generate the risk assessment or score. The supplemental authentication can be triggered when the risk score exceeds a risk threshold.

In some embodiments, a (machine) learning engine is provided that is configured to observe traffic over one or more servers of a platform to identify and classify the servers, e.g., based on security importance, and/or typical behavior occurring with respect to the servers, e.g., commands run on those servers, etc. The learning engine can predict whether requested behavior is outside the norm based on the typical behavior. In some embodiments, the typical behavior can be based on past behavior that occurred with respect to a particular machine or server or with respect to a similar machine or server. For example, the predictive behavior can be based on a type of server, server access permissions, etc.

In some embodiments, a tracking/logging engine is provided that is configured to maintain records corresponding to each authenticated connection. The records can include calendric and temporal data, executed command data, and/or one or more features of a feature set corresponding to the authenticated connection. The records can be video records, text-based records, etc., including combinations and/or variations thereof.

The techniques introduced herein can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

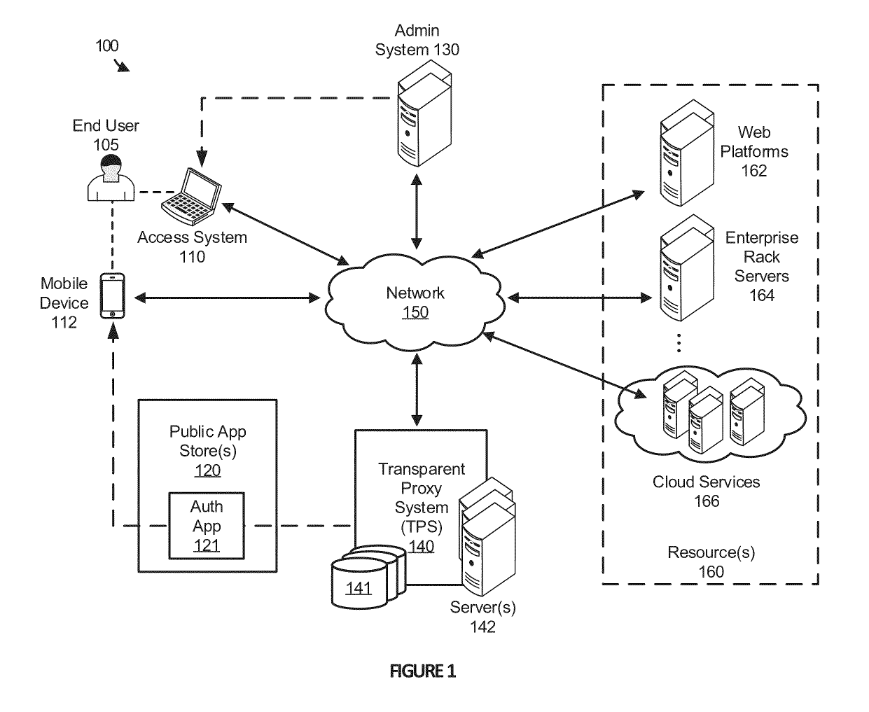

FIG. 1 depicts a block diagram illustrating an example environment 100 including a transparent proxy system 140 which is configured to observe and cluster resource(s) 160 associated with an enterprise and to transparently provide varying levels of dynamic protected access to the resource(s) 160. More specifically, the transparent proxy system 140 facilitates, among other things, dynamic triggering of supplemental authentication for access to the resource(s) 160.

As shown in the example of FIG. 1, environment 100 includes the access system 110, a mobile device 112, a public app store 120 having an authentication app 121 available for download, the transparent proxy system 140 including a database or storage unit 141 and one or more servers 142, and various resources 160. The transparent proxy system 140 can include one or more data stores 141 and one or more servers 142.

As shown, and by way of example and not limitation, the resources 160 can include, among other systems/platforms, web platforms 162, enterprise rack servers 164, and cloud services 166. In the example of FIG. 1, the access system 110 and the mobile device 112 are under the control of end user 105. A single end user 105, access device 110 and mobile device are shown for simplicity, the example environment 100 can include any number of end users operating access systems 110 and having corresponding mobile devices 112. Moreover, although shown as a single entity, it is appreciated that the transparent proxy system 140 can be physically and/or functionally distributed.

Prior to operation, one or more resources and devices are registered with transparent proxy system 140. For example, an administrator can register and/or otherwise resources 160 that are to be protected and the end users 105 can register details about a given resource and secondary security device(s), e.g., mobile device 112, with the transparent proxy system 140. In some embodiments, the device information can include contact information for secondary security devices such as, for example, a mobile number or IP address of an application operating on mobile device 112. Additionally, in some embodiments, an end user directs a secondary security device, e.g., mobile device 112 to download and installs the authentication app 121 from the public app store 120 on mobile device 112 as part of a registration process with the transparent proxy system 140.

In some embodiments, the registration details include at least some authentication or login credential information so that the user does not need to maintain (remember) and/or otherwise provide this information when accessing the resource. For example, an end user can provide username and password information for accessing the end user's Facebook™ account. Moreover, in the enterprise context, SSH keys can be registered and provided to the transparent proxy system 140. Additionally, the registration process can include selection and/or configuration of policies and policy information for primary and/or supplemental authentication. The policies can include, by way of example, relative device proximity policies, geofencing policies, biometric identification policies, movement policies, etc.

The relative device proximity policies can include, for example, directing the mobile device 112 and/or the access system 110 to detect and report on their proximity. In some embodiments, the proximity can be determined based on Bluetooth connectivity or a determination as to Bluetooth RSSI strength to ascertain a physical distance between the mobile device 112 and the access system 110 (e.g., the machine used to attempt to access the resource). In such cases, RSSI strength being greater than a threshold can indicate that the mobile device 112 and the access system 110 are sufficiently proximate to satisfy the relative device proximity policy.

The geofencing policies can include, for example, directing the mobile device 112 and/or the access system 110 to detect and report geolocation information. In some embodiments, the system may already have this information as part of the request. For example, the geolocation information can include the IP address used to access the resource. In other instances, the policies can be configured to request an IP address from the mobile device as well. In any case, access to the resource is granted only when the user is within a predetermined geographical location or area. If the access systems 110 and/or the mobile device 112 is outside that predetermined location or areas, then access is not granted.

The biometric identification policies can include, for example, directing the mobile device 112 and/or the access system 110 to obtain fingerprint, retina, face, voice or biometric based identification information from the end user 105 and to report the information to the transparent proxy system 140.

The movement policies can include, for example, directing the mobile device 112 and/or the access system 110 to obtain movement information from the end user 105. The movement can include an air signature such as, for example, movement of the mouse, or a registered device such as mobile phone 112 to make a signature in the air, including shaking of a device in a specific manner, etc.

In the various examples discussed herein, authentication information is primary requested from the mobile device 112 and/or the access system 110. It is appreciated that any number of devices (including secondary authentication devices) can be registered and the various polices configured to direct those devices to obtain and send information to the transparent proxy system 140 for authentication.

As discussed herein, authentication polices can be configured for conditional or unconditional multi-factor authentication. For example, as discussed in more detail below, in some embodiments, various score or risk factors can be used to determine whether multi-factor authentication is triggered or whether additional factors of the multi-factor authentication should be utilized by the system to authenticate the user.

Although not illustrated for simplicity, in the example operation of FIG. 1, the end user 105 has downloaded and installed the authentication app 121 from the public app store 120 onto mobile device 112.

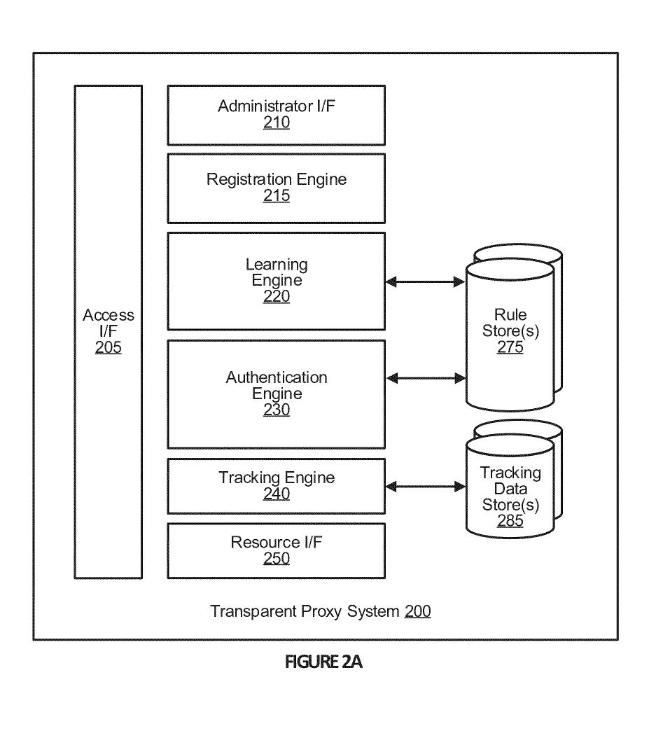

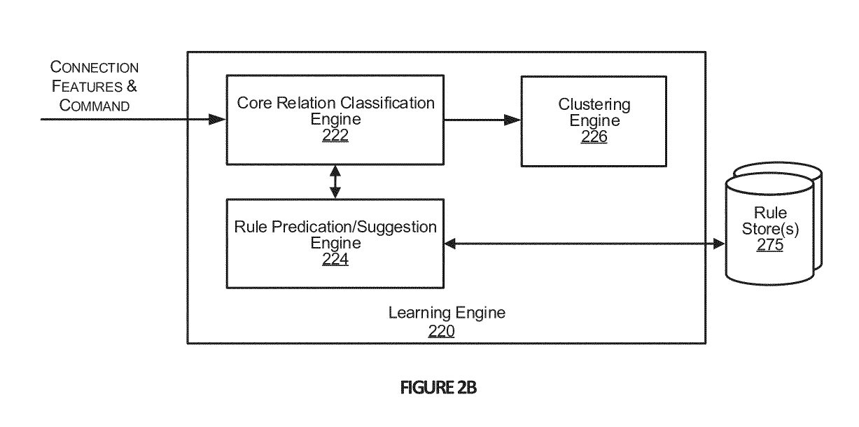

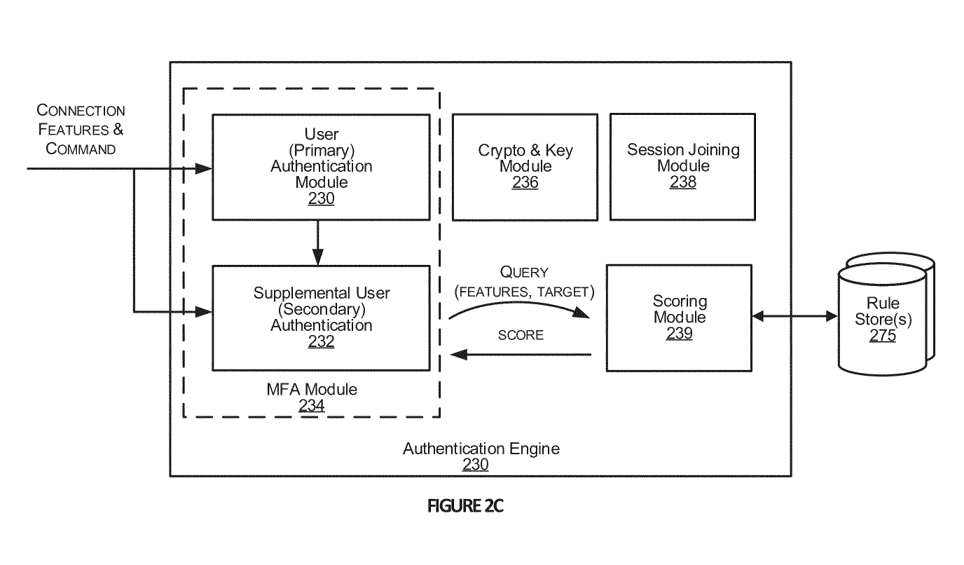

FIGS. 2A-2C depict example components of a transparent proxy system 200, according to some embodiments. The transparent proxy system 200 can be the transparent proxy system 140 of FIG. 1, although alternative configurations are possible. The functions represented by the components, modules and/or engines described herein can be implemented individually or in any combination thereof, partially or wholly, in hardware, software, or a combination of hardware and software.

As illustrated in the example of FIG. 2A, the transparent proxy system 200 includes an access interface 205, an administrator interface 210, a learning engine 220, an authentication engine 230, a tracking engine 240, a resource interface 250, one or more rule stores 275 and one or more tracking data stores 275. Other systems, databases, and/or components are also possible. Some or all of the components can be omitted in some embodiments.

The access interface 105 is configured to interface with access systems. For example, the access interface 105 can receive and/or otherwise intercept resource connections requests initiated by the access systems. In some embodiments, the access interface 105 can also, in whole or in part, extract feature sets from connections or connection requests. In other embodiments, the learning engine 220 and/or the authentication engine can alternatively or additionally extract some or all of the features from the feature sets of the connections or connection requests.

The feature sets can include various features including, but not limited to, the type or mechanism used to establish (or attempt to establish) the connection, locations of the access system and/or the resource, Internet Protocol (IP) addresses of the access system, the type and/or operating system of access system, the type, operating system, or function of the server to which the connection is requested (e.g., test servers, production servers, etc.). The access interface 105 can also extract a command that the end user is attempting to execute on the resource via the access system. For example, the end user can attempt to execute internal or external shell commands or shell scripts. The end user can use various types or mechanism to establish (or attempt to establish) the connection, e.g., Secure Shell (SSH), File Transfer Protocol (FTP), etc. Once a connection is established, the access interface 105 can relay messages back and forth between an access system and a protected resource.

The administrator interface 210 is configured to interface with enterprise administrators. For example, an enterprise administer can request that enterprise servers or resources be protected by transparent proxy system 200.

The registration engine 215 is configured to interface with an end user, administer, or bot to setup and/or update various resource registration information.

The (machine) learning engine 220 is configured to transparently observe traffic to resources, e.g., servers or systems, automatically detect typical behaviors and/or functions associated with the resources, and cluster and/or otherwise classify the resources based on their corresponding behaviors and/or functions. In some embodiments, each classification of resources can have different rules which are stored in the rules store(s) 277. The different rules provide varying levels of protected access to resource based on, for example, the importance of those resources. Example components of a learning engine 220 are shown and discussed in greater detail with reference to FIG. 2B.

The authentication engine 230 is configured to authenticate user access and dynamically provide risk assessment and automated triggering of supplemental authentication for protected access resources as discussed herein. Example components of an authentication engine 230 are shown and discussed in greater detail with reference to FIG. 2C.

The tracking engine 240 is configured to maintain records regarding each authenticated connection in the one or more tracking data store(s) 285. The tracking data stores can automatically and transparently maintain the forensic (evidence) records of what actions occurred, when they occurred, etc., making investigations seamless. The tracking data can include one or more features of the feature set corresponding to the authenticated connection including the date, time, location, IP address, what commands were executed, etc. In some embodiments, the tracking data includes a video record of each of the actions that were performed by an end user.

The resource interface 250 provides an interface for relaying information back and forth from a protected resource. As discussed herein, the resource interface 250 facilitates transparency with the resource so that neither the resource nor the access system is aware that traffic is being routed through the transparent proxy system 200.

Referring next to FIG. 2B which illustrates example components of a learning engine 220, according to some embodiments. As illustrated in the example of FIG. 2B, the learning engine 220 includes a core relation classification engine 222, a rule prediction/suggestion engine 224, and a clustering engine 226. Additional or fewer components/engines/modules are possible.

As discussed above, the learning engine 220 receives authenticated connection features and commands that are extracted and/or otherwise determined by the access interface 205. Alternatively or additionally, some or all of the authenticated connection features and commands can be determined by the learning engine 220.

The core relation classification engine 222 is configured to observe traffic during a learning period and subsequently analyze the traffic to identify core relation information. For example, the core relation classification engine 222 may analyze the features of each authenticated connection to identify typical behaviors, e.g., commands, etc., that are run on particular resources, which resources are more important than others, e.g., critical production servers vs. test, servers, etc.

The clustering engine 226 is configured to cluster related resources of an enterprise based on for example risk priority High, Med, Low. In some embodiments, clustered resources or systems can have the same or similar rules.

The rule prediction/suggestion engine 224 can analyze the traffic, etc., and suggest rules for particular resources based on typical behaviors, similar resources, who has accessed the resource, the type of resource, the type of access system, etc. The suggested rules can be approved/denied by an administrative user of the enterprise.

Referring now to FIG. 2C, which depicts example components of the authentication engine 230, according to some embodiments. As illustrated in the example of FIG. 2C, the authentication engine 230 includes an authentication (multi-factor) MFA module 235, a crypto & key module 236, a session joining module 238, and a scoring module 239. As shown in the example of FIG. 2C, the MFA module 235 includes a user (primary) authentication module 230 and a supplemental (secondary) user authentication module 232.

The authentication (multi-factor) module 234 is configured to provide a configurable multi-factor authentication. The multi-factor authentication is configured such that it is not intrusive, time consuming or confusing. The system can provide various multifactor authentication techniques that may seem invisible yet effective at ascertaining the authenticity of the identity of the end client. Additionally, the MFA module 234 includes a supplemental (secondary) user authentication module 232 which monitors commands, determines and maintains dynamic risk scores in conjunction with the scoring module 239 based on the commands, and triggers and performs the secondary authentication.

The primary and secondary or supplemental authentication options include but may not be limited only to (1) Bluetooth RSSI strength to ascertain how far physically a mobile or tablet device is from a machine used to access the resource (2) Geo-location fencing, based on the IP address used to access the resource, to make sure that access to the resource is granted only if the user is in certain geographical locations or is not granted of the user is in certain geographical locations. (3) Fingerprint, retina, face, voice or biometric based identification provided for by the device that is being used to access the resource or any other device that may have been registered as a second factor device by the end client (4) an air signature—movement of the mouse, or a device like a mobile phone to make a signature in the air, including shaking of a device in a specific manner and more.

The crypto & key module 236 is configured to securely store credentials for the end client, e.g., the access system and/or the end user, in the one or more data stores 275. For security, the stored credentials are encrypted. In some embodiments, the encryption can be accomplished through cryptography where multiple keys are generated and maintained on various machines not belonging to the end client.

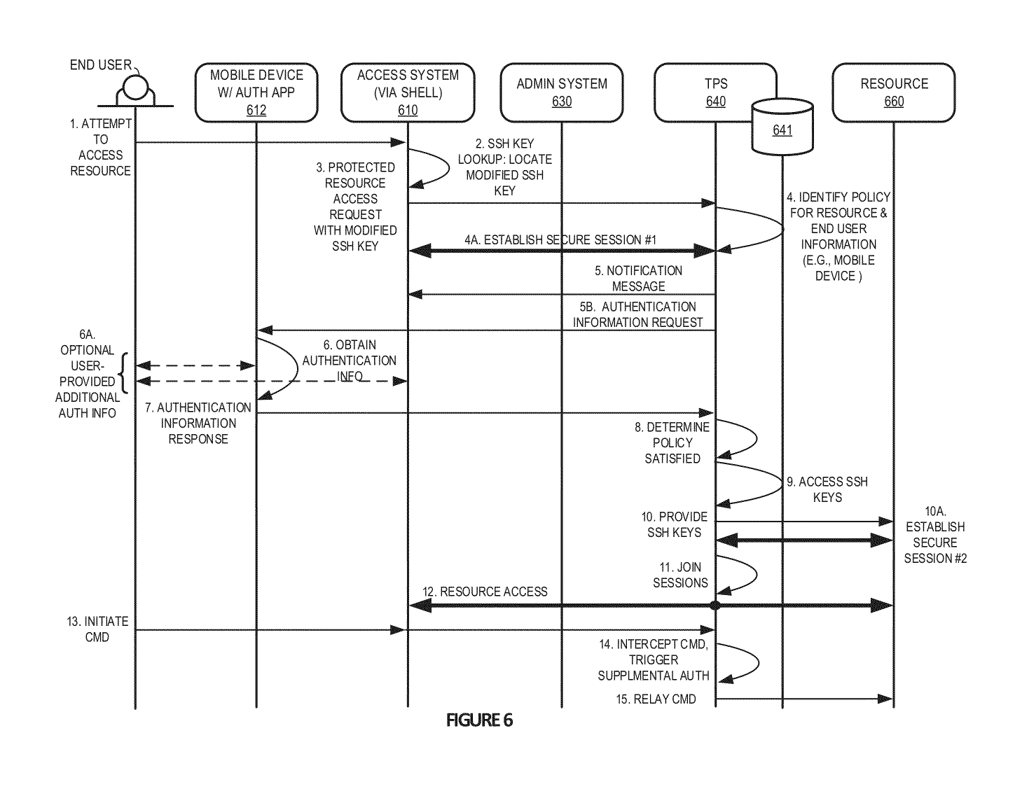

The session joining module 238 is configured to join multiple sessions as discussed herein. An example of session joining is shown and discussed in greater detail with reference to FIG. 6. In some embodiments the credentials may never be transferred in any way shape or form to the access system. In such instances, only session IDs are transferred to the device being used. The system can help expire the session after a specified amount of time as set by the administrator of the organization or the end client themselves.

For example, in some embodiments, the cloud store proceeds to provide the end client with a valid session ID whenever they would like to use a protected resource, by using the stored encrypted credentials and the encryption key of the end client used to store the credentials in the first place. This allows for passwords and usernames to never reach the clients computer yet provide a seamless login experience. Furthermore the system can use various factors to determine of the end client trying to access the resource is actually the person/end client allowed to do so or not by using various features on their mobile phones, tablets, google glass and other devices.

The scoring module 239 is configured to calculate a risk score based on the features of an authenticated connection and/or the command that the end use is attempting to execute. In some embodiments, the scoring module 239 can calculate a security level from the browsing behavior of an end client by generating a security-level evaluation, which is referred to herein as a score. By way of example, the score can be in the form of one or more of: a numerical score, an alphanumeric set of characters, or a visual identifier, such as color, sound, including combinations and/or variations thereof.

In some embodiments, the score can be used, for example, (a) to revoke a session ID to prevent an end user from accessing a resource, (b) as an answer to a third party or a resource that may choose to act upon it, (c) to ask the end user to for additional verification using other means. The score can be calculated in whole or in part at the transparent proxy system 140, the access system 110, and/or the mobile device 112, or any other electronic device.

In some embodiments, the system assesses, summarizes and depicts the security level of a browsing session that is allowing an end client to access a resource by generating a security-level score. The score can be in the form of a numerical score, an alphanumeric set of characters, and/or a visual identifier, such as color, sound, etc. In some embodiments, the goal of the score is to identify if the browsing behavior of the person who is accessing the protected resources deviates from the learned experience that has been taught to the system.

In some embodiments, the score can be generated based on any number of factors and can consider various broad categories. By way of example, the score can consider the following broad categories: the browsing behavior of the end client such as mouse pointer speed, scrolling speed, focus of the actions being performed on a webpage and more; external and historical information about how users are using the website; the likelihood of the end client accessing the resource at the time it is being accessed, where it is being accessed from and more; additional features that aid in the identification and/or classification of an end client's browsing behavior; etc.

In some embodiments, the score is calculated or generated using a multi-level approach which can be implemented as a hierarchy of modules. In some instances, a separate partial score can generated for each of these multiple categories. For example, there can be a module for each category and each module may consist of additional modules assessing specific aspects. In some embodiments, the system analyzes a site along multiple dimensions (i.e., with respect to a plurality of different website properties). The partial scores can then collected and combined by an integration module to generate the final score.

In some embodiments, the various techniques discussed herein may be performed a client side web-browser extension, a proxy, or a computer program that runs on an access system or secondary authentication device. The calculation of the score can use one mathematical function that incorporates all the indications and information pertinent to verifying the authenticity of the end client's, e.g., access systems, attempt to access the resource.

In some embodiments, the mechanism to calculate the security level of a site is highly customizable allowing the addition or deletion of parameters and factors, as the technology and business practices evolve.

In some embodiments, the security level of a site, can be represented in a non-limiting way as: (a) a numerical score, (b) an alphanumeric set of characters (e.g., B+), (c) a visual identifier, such as color, (d) a sound, (e) a graphical depiction such as a plot, or a set of multiple instances of all the above. Additionally, the system can generate detailed reports showing why the security level of a site is as reported and accompanied by optional tips on how to improve the score. The level of detail of this information can be defined by a tunable parameter that ranges from the raw output of all the data that the invention processed or it can be aggregated at an easier-to-understand level of granularity.

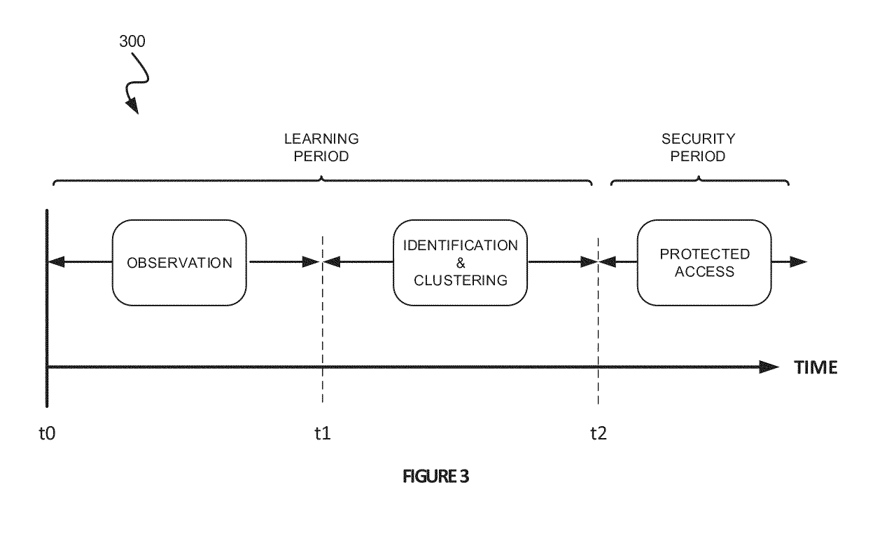

FIG. 3 depicts an example timeline 300 illustrating a learning period and security period of a transparent proxy system when serving resources associated with a particular enterprise, according to some embodiments. As discussed herein the learning period includes a traffic observation period and an identification and clustering period. Once the learning period is completed, traffic to the resources is transparently protected and monitored as discussed herein.

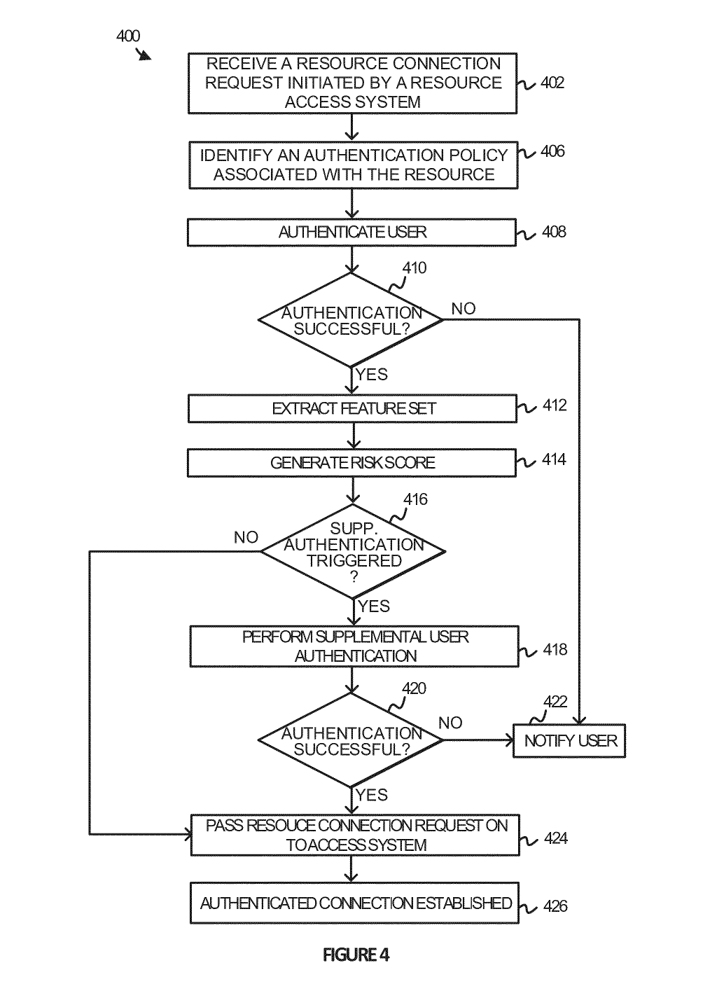

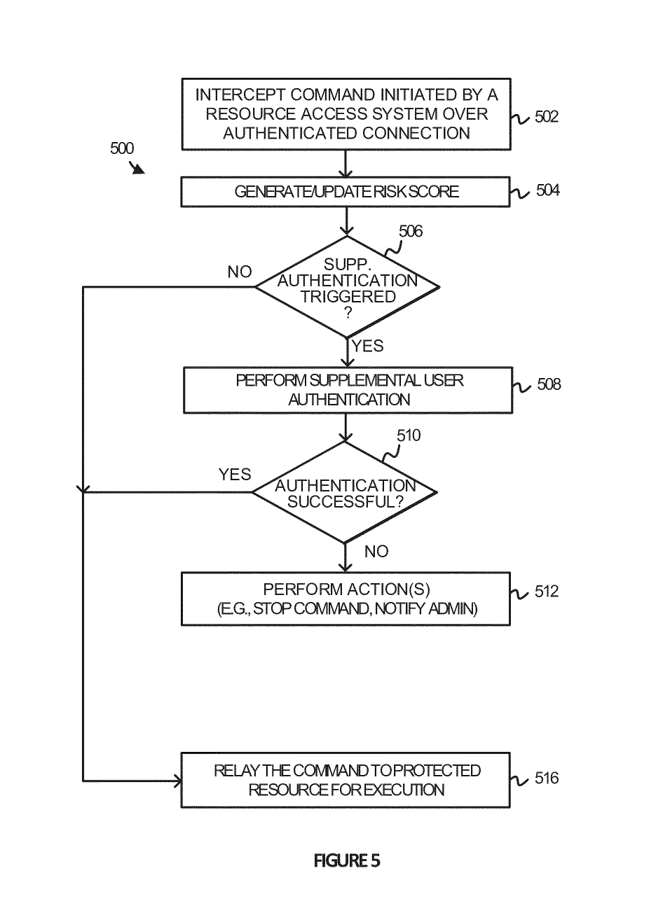

FIGS. 4 and 5 depict a flow diagram illustrating example operations 400 and 500 respectively for facilitating dynamic risk assessment and automated triggering of supplemental authentication for a protected access resource, according to some embodiments. More specifically, the example of FIG. 4 illustrates generation of an initial risk score when a protected resource is first access via an authenticated connection while FIG. 5 illustrates dynamic updating of the risk score based on intercepted commands. The example operations 400 and 500 may be performed in various embodiments by a transparent proxy system such as, for example transparent proxy system 140 of FIG. 1 or 200 of FIG. 2, or one or more processors, and/or other modules, engines, components or tools associated with a transparent proxy system.

Operations 400 and 500 illustrate operations during a protected access security period (see FIG. 3). It is assumed that, prior to commencement of operation 400, one or more resources have been observed, identified and clustered during the learning period. Alternatively, an administrator can manually apply or enter rules.

Referring first to FIG. 4, to begin, at step 402, the transparent proxy system receives a resource connection request initiated by an access system. At step 406, the transparent proxy system identifies an authentication policy associated with the resource. The authentication policy can include different authentication requirements for both primary and supplemental authentication. For example, supplemental authentication may require more authentication information from a user as it is triggered when a risk score exceeds a threshold. At step 408, the primary authentication is performed to verify the identity of the user. In some embodiments, primary authentication can simply require the user to provide appropriate credential for a resource. However, as discussed other authentication may also be required. At decision step 410, the transparent proxy system determines if the primary authentication is successful. If not, the user (and possibly others including an administrator) is notified.

If the primary authentication is successful, an authenticated connection is established and, at step 412, the transparent proxy system extracts a feature set of the authenticated connection.

At step 414, the transparent proxy system generates a risk score based on the feature set initiated by a user over the authenticated connection. If the risk score exceeds a risk threshold, at step 416, the transparent proxy system triggers supplemental authentication. At step 418, the transparent proxy system performs the supplemental authentication. If the supplemental authentication is successful, at step 424, the resource connection request is passed on to the access system. Otherwise, at step 422, the user (and possibly others including an administrator) are notified. Lastly, at step 424, an authenticated connection is established between the access system and the resource by way of the transparent proxy system.

Referring next to FIG. 5 which, as discussed above, illustrates dynamic command-level risk assessment monitoring and updating of a risk score based on commands intercepted on a previously authenticated connection. Prior to commencement of operation 500, it is assumed that an authenticated connection is established between an access system and the resource by way of a transparent proxy system (e.g., as shown and discussed in FIG. 4).

To begin, at step 502, the transparent proxy system intercepts a command initiated by a resource access system over the authenticated connection. At step 504, the transparent proxy system generates and/or otherwise updates a dynamic risk score. At decision step 506, the transparent proxy system determines if supplemental authentication is triggers. As discussed, in some embodiments, supplemental authentication can be triggered if the risk score exceeds a risk threshold. If triggered, at step 508, the transparent proxy system performs supplemental user authentication.

At decision step 510, the transparent proxy system determines if the authentication was successful. If the authentication is not successful, at step 512, the transparent proxy system can perform one or more actions. The actions can include stopping the command from executing, e.g., by not relaying the command to the resource, notifying an administrator, etc., including combinations and/or variations thereof.

However, if the authentication is successful, at step 516, the transparent proxy system relays the command to the protected resource for execution of the command by the resource. For example, the end user might be attempting to delete a large swath of files which causes the system to request biometric data to verify the identity of the end user. If the appropriate biometric data is provided during the supplemental authentication, the delete command can be relayed to the protected resource.

FIG. 6 depicts a sequence diagram illustrating example operation of various devices, systems, and an end users for establishing an authenticated connection and subsequently triggering a supplemental authentication based on an intercepted command, according to some embodiments. More specifically, FIG. 6 illustrates a scenario in which an end user (employee) gains credential-free access to an enterprise system resource such as, for example, enterprise rack servers 164 of FIG. 1 and supplemental authentication is subsequently triggered as a result of a command initiated by an end user.

The example of FIG. 6 includes a secondary authentication device (mobile device 612 having an authentication application installed thereon), an access system with a browser extension 610, an administrator system 630, a transparent proxy system 640 with data store 641, and a resource 660. Initially, at step 1, the end user (employee) attempts to access the resource. For example, the end user may open a CLI shell and attempt to login to a server by typing an ssh command. At step 2, the SSH looks up the SSH-keys stored in the .ssh directory on the system and creates a fingerprint indicating that the end user (employee) is trying to connect to resource 660 (server). In the example of FIG. 6, the SSH key that is stored in the .ssh directory is a modified SSH key that points to the transparent proxy system 640. The modified SSH key is used to obtain the actual SSH key at the transparent proxy system 640.

At step 3, a protected resource access request is generated and sent to the transparent proxy system 540. The protected resource access request includes the modified SSH key. At step 4, the transparent proxy system 640 processes the protected resource access request to identify a predetermined authentication policy corresponding to the privileged resource and various end user information for verifying the identity of the end user. For example, the end user information can include information about a secondary authentication device, i.e., the mobile device 612. At step 4A, a secure session is established between the access system 610 and the transparent proxy system 640. Optionally, at step 5A, the transparent proxy system 640 responsively generates and sends a notification message to the access system. The notification message can be displayed by the access system to the end user and indicate a variety of information.

Once the secondary authentication device (mobile device 562) is identified, at step 5B, the transparent proxy system 640 generates and sends an authentication information request to the secondary authentication device (mobile device 612). The authentication information request indicates additional information to be obtained by the secondary authentication device. As discussed above, the additional information that is requested can be determined by the policy or policies that are preconfigured for accessing the resource during the registration process. By way of example, the additional information can include relative device proximity information, geolocation information (e.g., GPS or IP information), biometric information, device movement information, PIN information, etc. Although a single request for information is shown, it is appreciated that the transparent proxy system 640 may request additional information more than once depending on the policy and/or the information obtained in the authentication information responses.

In some embodiments, the authorization application running on the mobile device processes the authentication information request and, at step 6, obtains the requested information. As discussed, in some instances, the mobile device, at step 6A, can request that the user provide some input, e.g., movements, fingerprint, retinal scan, etc. Once the requested information is obtained, at step 7, the mobile device 612 generates and sends an authentication information response to the transparent proxy system 640. At step 8, the transparent proxy system 640 processes the response to determine whether the policy is satisfies. If so, at step 9, the transparent proxy system 640 accesses the SSH key from the data store 641. In some embodiments, the SSH key might need to be decrypted at the transparent proxy system 640.

At step 10, the transparent proxy system 640 provides the SSH key to the resource 660 and, at step 10A establishes a secure session between the transparent proxy system 640 and the resource 660. At step 11, the sessions are joined resulting in resource access at step 12.

The resource access in the example of FIG. 6 is discusses with reference to a zero-password login scenario. It is appreciated that the learning systems discussed herein with command-level monitoring for triggering secondary authentication can also be used on systems that do not support zero-password login functionality.

At step 13, a command is initiated by the end user. At step 14, the transparent proxy system intercepts the command, generates/updates a risk score and determines whether to trigger supplemental authentication. If triggered, the supplemental authentication is performed as discussed herein. If the supplemental authentication is not triggered or if the supplemental authentication is successful, at step 15, the transparent proxy system relays the command to the resource over the authenticated connection.

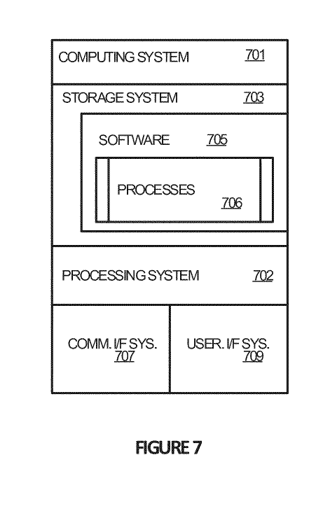

FIG. 7 illustrates computing system 701 that is representative of any system or collection of systems in which the various operational architectures, scenarios, and processes disclosed herein may be implemented. Examples of computing system 701 include, but are not limited to, smart phones, laptop computers, tablet computers, desktop computers, hybrid computers, gaming machines, virtual machines, smart televisions, smart watches and other wearable devices, as well as any variation or combination thereof. In other examples, other types of computers may be involved in the processes, including server computers, rack servers, web servers, cloud computing platforms, and data center equipment, as well as any other type of physical or virtual server machine, and any variation or combination thereof.

Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709. Processing system 702 is operatively coupled with storage system 703, communication interface system 707, and user interface system 709.)

Processing system 702 loads and executes software 705 from storage system 503. Software 705 can include a various example processes, which are representative of the processes discussed with respect to the preceding FIGS. 1-6. When executed by processing system 702 to facilitate secure credential-free user access to resources, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device, but may also be distributed across multiple processing devices or sub-systems that cooperate in executing program instructions. Examples of processing system 702 include general purpose central processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device, but may also be implemented across multiple storage devices or sub-systems co-located or distributed relative to each other. Storage system 703 may comprise additional elements, such as a controller, capable of communicating with processing system 702 or possibly other systems.

Software 705 may be implemented in program instructions and among other functions may, when executed by processing system 702, direct processing system 702 to operate as described with respect to the various operational scenarios, sequences, and processes illustrated herein. For example, software 705 may include program instructions for implementing enhanced callback operations and related functionality.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software or other application software, in addition to or that include callback process 706. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to facilitate enhanced callback operations. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

It may be understood that computing system 701 is generally intended to represent a computing system or systems on which software 705 may be deployed and executed in order to implement enhanced callback operations. However, computing system 701 may also be suitable as any computing system on which software 705 may be staged and from where it may be distributed, transported, downloaded, or otherwise provided to yet another computing system for deployment and execution, or yet additional distribution.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 709 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 709. In some cases, the input and output devices may be combined in a single device, such as a display capable of displaying images and receiving touch gestures. The aforementioned user input and output devices are well known in the art and need not be discussed at length here.

User interface system 709 may also include associated user interface software executable by processing system 702 in support of the various user input and output devices discussed above. Separately or in conjunction with each other and other hardware and software elements, the user interface software and user interface devices may support a graphical user interface, a natural user interface, or any other type of user interface.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A transparent proxy system comprising:
one or more processors; and
one or more computer readable storage media having program instructions stored thereon which, when executed by the one or more processors, cause the transparent proxy system to:
intercept a command initiated by a resource access system over an authenticated connection, wherein the command is initiated for delivery to and execution by a protected resource;
generate a risk score based on a type of the command and a feature set corresponding to the authenticated connection; and
trigger a supplemental authentication if the risk score exceeds a risk threshold.

2. The transparent proxy system of claim 1, wherein the instructions, when executed by the one or more processors, further cause the transparent proxy system to maintain records corresponding to each authenticated connection.

3. The transparent proxy system of claim 2, wherein the records include one or more of calendric and temporal data, executed command data, and one or more features of the feature set corresponding to the authenticated connection.

4. The transparent proxy system of claim 2, wherein the records comprises video data.

5. The transparent proxy system of claim 1, wherein the instructions, when executed by the one or more processors, further cause the transparent proxy system to perform the supplementation authentication.

6. The transparent proxy system of claim 5, wherein the instructions, when executed by the one or more processors, further cause the transparent proxy system to relay the command to the protected resource for execution when the supplemental authentication is satisfied.

7. The transparent proxy system of claim 5, wherein the instructions, when executed by the one or more processors, further cause the transparent proxy system to perform one or more pre-determined actions when the supplemental authentication is not satisfied.

8. The transparent proxy system of claim 5, wherein the supplemental authentication comprises authenticating the user via a second device associated with the user.

9. The transparent proxy system of claim 8, wherein to perform the supplementation authentication, the instructions, when executed by the one or more processors, further cause the transparent proxy system to request geolocation information including one or more of GPS information or Internet Protocol address information from the second device, wherein the supplemental authentication comprises a geofencing policy that is satisfied when the second device is determined to be located within a predetermined area.

10. The transparent proxy system of claim 8, wherein to perform the supplementation authentication, the instructions, when executed by the one or more processors, further cause the transparent proxy system to request proximity information indicating a proximity between the second device and the resource access system, wherein the supplemental authentication comprises a proximity policy that is satisfied when the second device is within a predetermined distance to the resource access system.

11. The transparent proxy system of claim 10, wherein an established Bluetooth connection is indicative of the second device and the resource access system being sufficiently proximate to satisfy the proximity policy.

12. The transparent proxy system of claim 8, wherein to perform the supplementation authentication, the instructions, when executed by the one or more processors, further cause the transparent proxy system to request fingerprint, retina, face, voice or biometric based identification from the user via the second device.

13. The transparent proxy system of claim 1, further comprising extracting the feature set in response to a resource connection request initiated by the resource access system.

14. The transparent proxy system of claim 1, wherein the command is initiated by the resource access system via one or more of Secure Shell (SSH) or File Transfer Protocol (FTP).

15. A method of operating a transparent proxy system, the method comprising:
intercepting a command initiated by a resource access system over an authenticated connection,
wherein the command is initiated for delivery to and execution by a protected resource;
generating a risk score based on a type of the command and a feature set corresponding to the authenticated connection; and
performing a supplemental authentication if the risk score exceeds a risk threshold.

16. The method of claim 14, further comprising maintain records corresponding to each authenticated connection, wherein the records include one or more of calendric and temporal data, executed command data, and one or more features of the feature set corresponding to the authenticated connection.

17. The method of claim 15, wherein the records comprises video data.

18. The method of claim 14, further comprising:
relaying the command to the protected resource for execution when the supplemental authentication is satisfied.

19. The method of claim 14, wherein the supplemental authentication comprises authenticating the user via a second device associated with the user.

20. A computer readable storage media having program instructions stored thereon which, when executed by the one or more processors, cause the one or more processors to:
intercept a command initiated by a resource access system over an authenticated connection, wherein the command is initiated for delivery to and execution by a protected resource;
generate a risk score based on a feature set corresponding to the authenticated connection and the command; and
trigger a supplemental authentication if the risk score exceeds a risk threshold.
